(19) United States
(12) Patent Application Publication
(10) Pub. No.: US 2023/0011459 A1
(43) Pub. Date: Jan. 12, 2023

(54) MULTI-PURPOSE COFFEE CAPSULE STORAGE DRAWER

(71) Applicant: Xiaofeng LIU, Foshan City (CN)

(72) Inventor: Xiaofeng LIU, Foshan City (CN)

(21) Appl. No.: 17/651,399

(22) Filed: Feb. 16, 2022

(30) Foreign Application Priority Data
Jul. 12, 2021 (CN) 202121580067.9

(51) Int. Cl. A47B 88/981; A47J 31/44

(52) U.S. Cl. CPC A47B 88/981; A47J 31/44

(57) ABSTRACT

A multi-purpose coffee capsule storage drawer includes a drawer body for storage of coffee capsules. The drawer body is internally provided with a plurality of rows of positioning groups that are parallel to each other. A storage cavity for storing the coffee capsule is formed between two adjacent positioning groups. Each row of positioning groups includes a plurality of protruding columns extending along the height direction of the drawer body and arranged front and rear. A clamping groove for clamping a flange of the coffee capsule is formed between two adjacent protruding columns. With the storage drawer of this structure, the capsules can be stored horizontally or vertically, which is flexible in storage method, capsules of different sizes can be stored, the coffee capsules stored are positioned stably, and multiple coffee capsules can be compact in storage, which can save the space of the storage cavity in the drawer body.

### CROSS REFERENCE TO RELATED APPLICATION

This application claims priority benefit of Chinese Patent Application No. 202121580067.9, filed on Jul. 12, 2021, and the entire contents of which are incorporated herein by reference.

### TECHNICAL FIELD

The present disclosure relates to the field of coffee capsules, in particular to a multi-purpose coffee capsule storage drawer.

### BACKGROUND

At present, coffee is one of the most common daily drinks, and people have stricter requirements on the quality and taste of coffee. Therefore, a coffee capsule is born at the right moment on the market.

The coffee capsule has the advantages that since a capsule wall has relatively hard texture, and can maintain the original shape well at high temperature, high-pressure water vapor can be injected into the capsule to make the coffee be completely precipitated under the action of pressure to obtain rich espresso with crema. In this way, the aroma of the coffee can be better ensured. As for preservation, the capsule is filled with non-toxic inert gas, which can prolong the shelf life and re-sterilize the coffee stored therein.

However, the current coffee capsules are generally stored in cartons. When parts of the coffee capsules are used, the remaining coffee capsules are easy to shift in the carton. Therefore, when users need coffee with specified tastes, they need to search in multiple coffee capsules one by one. Hence, it is necessary to provide a new storage solution for customers to choose.

### SUMMARY

The present disclosure aims to solve the existing problems above, and provide a multi-purpose coffee capsule storage drawer with a simple and reasonable structure, which mainly serves to realize the horizontal or vertical storage of capsules, and the storage of coffee capsules of different sizes.

A multi-purpose coffee capsule storage drawer includes a drawer body for storage of coffee capsules, where the drawer body is internally provided with a plurality of rows of positioning groups that are parallel to each other, a storage cavity for storing the coffee capsule is formed between two adjacent positioning groups, each row of positioning groups includes a plurality of protruding columns extending along the height direction of the drawer body, the protruding columns are arranged front and rear along the drawer body, and a clamping groove for clamping a flange of the coffee capsule is formed between two adjacent protruding columns.

A connecting rib is disposed between two adjacent protruding columns in the same row, and the connecting rib divides the clamping groove into two bayonets at left and right.

The protruding column is provided with an intermediate dividing groove along the front-rear direction of the drawer body, and the intermediate dividing groove divides the protruding column into two independent parts at left and right.

The coffee capsules are stored in the storage cavity in vertical arrangement, or stored in the storage cavity in horizontal arrangement.

The width of the aftermost clamping groove of each row of positioning groups is greater than that of the remaining clamping grooves.

The widths of the plurality of storage cavities are the same, or partially the same, or different from each other.

The drawer body includes a drawer bottom wall, and the protruding column is at least integrally formed with the drawer bottom wall by injection molding or pressing.

The protruding column is in the shape of a rectangular column, or a circular column, or an elliptical column, or a polygonal column or an irregular column.

An outer frame is further included. The drawer body is installed in the outer frame in a pull-out manner, and the plurality of protruding columns in each row of positioning groups are arranged along the pull-out direction.

Roller grooves are disposed on two sides of the drawer body, and rollers slidably matched with the roller grooves are disposed on corresponding two sides of the outer frame.

A handle is installed on the front end side of the drawer body.

The present disclosure has the following beneficial effects:

The multi-purpose coffee capsule storage drawer of the present disclosure is simple in structure and reasonable in layout. With the storage drawer of this structure, the capsules can be stored horizontally or vertically, which is flexible in storage method, capsules of different sizes can be stored, the coffee capsules stored are positioned stably, and multiple coffee capsules can be compact in storage, which can save the space of the storage cavity in the drawer body and maximizes the storage quantity.

### BRIEF DESCRIPTION OF THE DRAWINGS

FIG. 1 shows a structure and a partial enlarged view of Embodiment 1 of the present disclosure.

FIG. 2 shows a structure and a partial enlarged view of Embodiment 2 of the present disclosure.

FIG. 3 is a schematic diagram of coffee capsules in vertical arrangement of the present disclosure.

FIG. 4 is a schematic diagram of coffee capsules in horizontal arrangement of the present disclosure.

FIG. 5 is a schematic diagram showing exploded structures of a drawer body and an outer frame of the present disclosure.

FIG. 6 shows a structure and a partial enlarged view of Embodiment 3 of the present disclosure.

### DETAILED DESCRIPTION OF THE EMBODIMENTS

The present disclosure will be further described below in conjunction with the drawings and embodiments.

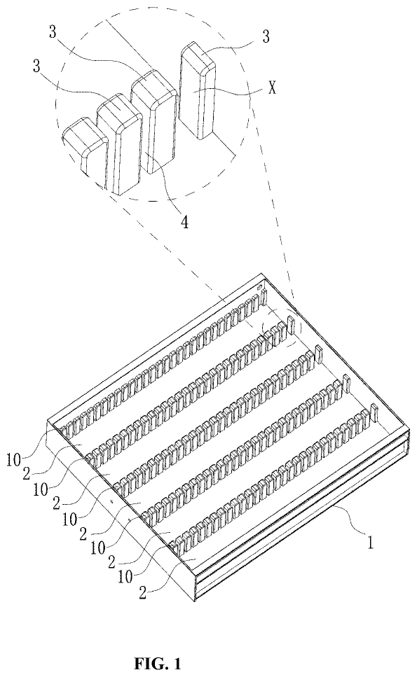

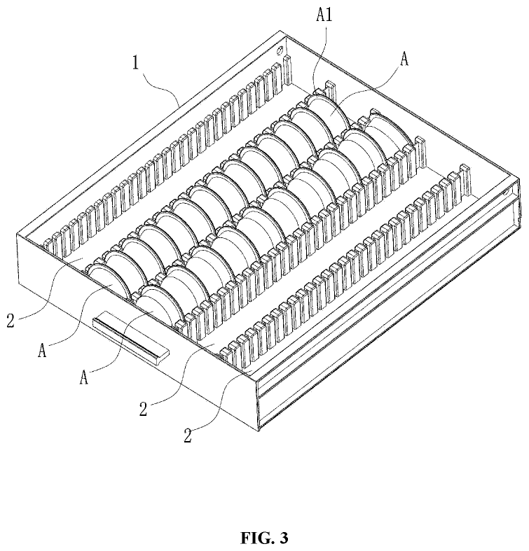

Embodiment 1: as shown in FIG. 1 and FIG. 3, a multi-purpose coffee capsule storage drawer includes a drawer body 1 for storage of coffee capsules A. The drawer body 1 is internally provided with a plurality of rows of positioning groups 10 that are parallel to each other. A storage cavity 2 for storing the coffee capsule A is formed between two adjacent positioning groups 10. Each row of positioning groups 10 includes a plurality of protruding columns 3 extending along the height direction of the drawer body 1. The protruding columns 3 are arranged front and rear along the drawer body 1, i.e., arranged along the pull-out direction of the drawer body 1. A clamping groove 4 for clamping a flange A1 of the coffee capsule A is formed between two adjacent protruding columns 3. With the storage drawer of this structure, the capsules can be stored horizontally or vertically, which is flexible in storage method, capsules of different sizes can be stored, the coffee capsules A stored are positioned stably, and multiple coffee capsules A can be compact in storage, which can save the space of the storage cavity 2 in the drawer body 1 and maximizes the storage quantity.

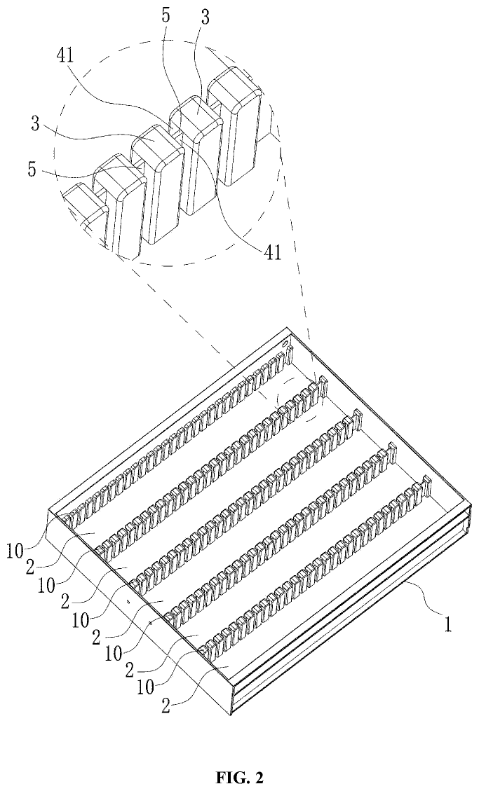

Embodiment 2: as shown in FIG. 2, a connecting rib 5 is disposed between two adjacent protruding columns (3) in the same row of positioning groups 10. The connecting rib 5 divides the clamping groove 4 into two bayonets 41 at left and right, such that the flanges A1 of the coffee capsules A in the adjacent storage cavity 2 do not interfere with each other, and the space in which the coffee capsules A moves to the left and right is reduced, which makes the coffee capsules A more compact after being stored and fixed.

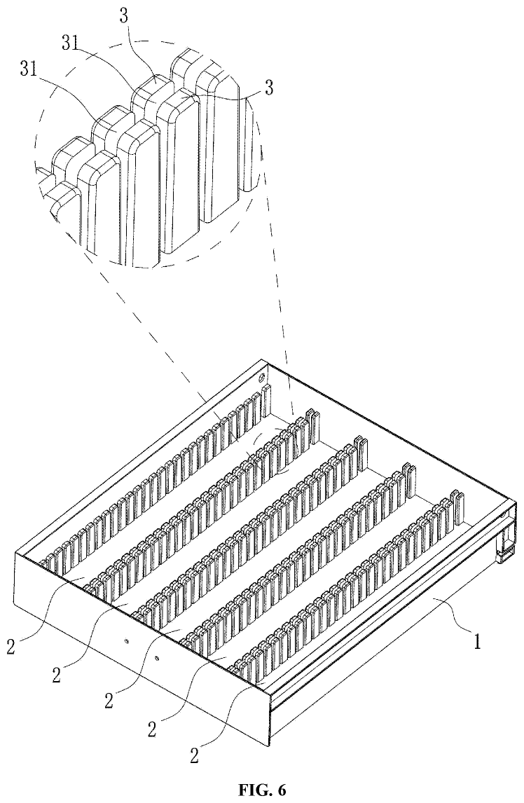

Embodiment 3: as shown in FIG. 6, the protruding column 3 is provided with an intermediate dividing groove 31 along the pull-out direction of the drawer body 1, and the intermediate dividing groove 31 divides the protruding column 3 into two independent parts at left and right.

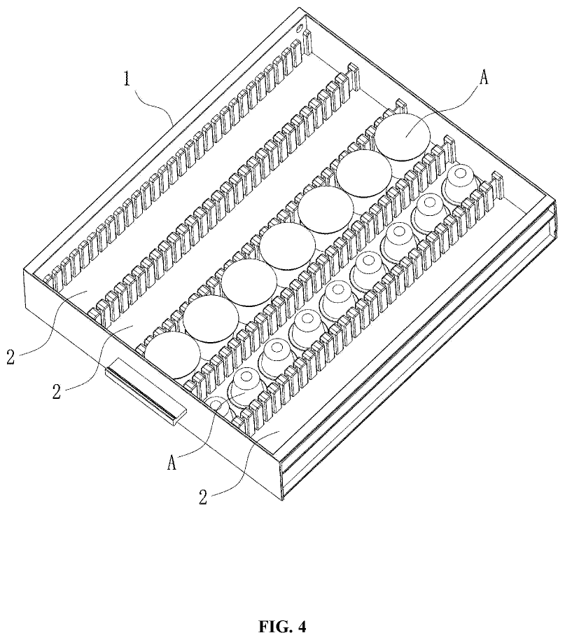

Further, as shown in FIG. 3, the coffee capsules A are stored in the storage cavity 2 in vertical arrangement, with flanges A1 clamped into the clamping groove 4 or the bayonet 41. By this storage method, the coffee capsules A are fixed better and won't slide back and forth, left and right, and multiple coffee capsules A are more compact in arrangement, which can increase the storage quantity of the coffee capsules A. Alternatively, as shown in FIG. 4, the coffee capsules A are stored in the storage cavity 2 in horizontal arrangement. By two rows of positioning groups 10 at left and right, the left and right positions of the coffee capsules A are limited, such that the coffee capsules A can be stored in orderly arrangement. Moreover, by storing the coffee capsules A in horizontal arrangement, with sealing films of the coffee capsules A facing upwards, it is convenient for users to observe the taste information of the coffee capsules A and realize rapid extraction.

Further, the width of the aftermost clamping groove (marked with X in FIG. 1) of each row of positioning groups 10 is greater than that of the remaining clamping grooves 4. Since the height of the coffee capsules A is not fixed, when the coffee capsules A are stored in the storage cavity 2 in vertical arrangement, the remaining space in the storage cavity 2 will be different. With the widened clamping groove 4, it can be ensured that one more coffee capsule A can be stored in the remaining space, without wasting the storage space.

Further, the widths of the plurality of storage cavities (2) are the same, or partially the same, or different from each other. In this embodiment, the solution where the widths of the storage cavity 2 are the same is preferable, and this solution is suitable for the storage of the same type of coffee capsules A.

In addition, the widths of the plurality of storage cavities 2 may be divided into two or more types according to production needs, or the widths of all storage cavity 2 may be different, which can be applied to the storage of coffee capsules A with different specifications.

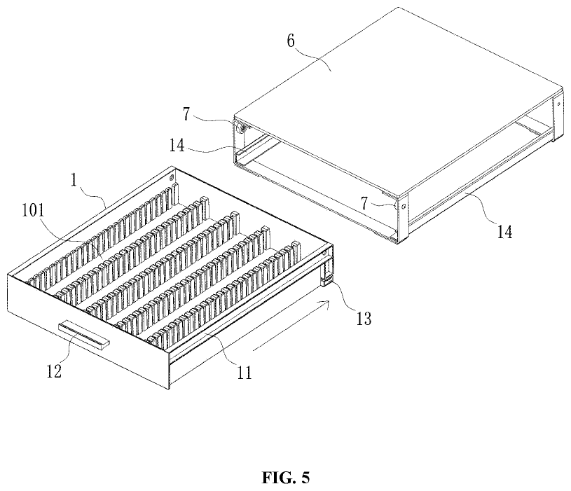

Further, as shown in FIG. 5, the drawer body 1 includes a drawer bottom wall 101. The protruding column 3 is integrally formed with the drawer bottom wall 101 by injection molding or pressing. Therefore, the structure is simple, the production is convenient, and the production efficiency is improved. Since the drawer body 1 is provided with a plurality of protruding columns 3, it is not suitable for fixing by welding, which will cause the problems such as too low production efficiency.

Further, the protruding column 3 is in the shape of a rectangular column, or a circular column, or an elliptical column, or a polygonal column or an irregular column. In the embodiment, the protruding column 3 preferably uses a rectangular column structure, as shown in the drawings.

Further, as shown in FIG. 5, the multi-purpose coffee capsule storage drawer further includes an outer frame 6. The drawer body 1 is installed in the outer frame 6 in a pull-out manner, and the plurality of protruding columns 3 in each row of positioning groups 10 are arranged along the pull-out direction. The outer frame 6 can protect the coffee capsules A in the drawer body 1.

Further, roller grooves 11 are disposed on two sides of the drawer body 1. Rollers 7 slidably matched with the roller grooves 11 are disposed on corresponding two sides of the outer frame 6. Compared with the prior art that the drawer body 1 is simply in sliding friction fit with the outer frame 6, the sliding fit of this structure is smoother, quieter, and longer in service life.

In addition, when the drawer body 1 is pulled out from the outer frame 6 more than halfway, the center of gravity will beyond the front edge of the outer frame 6, which causes the front end of the drawer body 1 to sink. Therefore, the clamping groove 13 is disposed at the rear end of the drawer body 1, a guide rail 14 matched with the clamping groove 13 is added to the outer frame 6, and the guide rail 14 is inserted into the clamping groove 13, such that after the drawer body 1 is pulled out more than halfway, the front end of the drawer body 1 will not sink, and will remain basically horizontal.

Further, a handle 12 is installed on the front end side of the drawer body 1. The drawer body 1 is conveniently pulled out through the handle 12.

The above descriptions are the preferred solutions of the present disclosure, which show and describe the basic principles, main features and advantages of the present disclosure. Those skilled in the art should understand that the present disclosure is not limited by the embodiments mentioned above. The embodiments and the descriptions mentioned above only illustrate the principles of the present disclosure, there may be various changes and improvements to the present disclosure without departing from the spirit and scope of the present disclosure, such changes and improvements fall within the scope of protection of the present disclosure, and the scope of protection of the present disclosure is defined by the appended claims and equivalents thereof.

What is claimed is:

1. A multi-purpose coffee capsule storage drawer, comprising a drawer body (1) for storage of coffee capsules (A), wherein the drawer body (1) is internally provided with a plurality of rows of positioning groups (10) that are parallel to each other, a storage cavity (2) for storing the coffee capsule (A) is formed between two adjacent positioning groups (10), each row of positioning groups (10) comprises a plurality of protruding columns (3) extending along the height direction of the drawer body (1), the protruding columns (3) are arranged front and rear along the drawer body (1), and a clamping groove (4) for clamping a flange (A1) of the coffee capsule (A) is formed between two adjacent protruding columns (3).

2. The multi-purpose coffee capsule storage drawer according to claim 1, wherein a connecting rib (5) is disposed between two adjacent protruding columns (3) in the same row, and the connecting rib (5) divides the clamping groove (4) into two bayonets (41) at left and right.

3. The multi-purpose coffee capsule storage drawer according to claim 1, wherein the protruding column (3) is provided with an intermediate dividing groove (31) along the front-rear direction of the drawer body (1), and the intermediate dividing groove (31) divides the protruding column (3) into two independent parts at left and right.

4. The multi-purpose coffee capsule storage drawer according to claim 1, wherein the coffee capsules (A) are stored in the storage cavity (2) in vertical arrangement, or stored in the storage cavity (2) in horizontal arrangement.

5. The multi-purpose coffee capsule storage drawer according to claim 1, wherein the width of the aftermost clamping groove (4) of each row of positioning groups (10) is greater than that of the remaining clamping grooves (4).

6. The multi-purpose coffee capsule storage drawer according to claim 1, wherein the widths of the plurality of storage cavities (2) are the same, or partially the same, or different from each other.

7. The multi-purpose coffee capsule storage drawer according to claim 1, wherein the drawer body (1) comprises a drawer bottom wall (101), and the protruding column (3) is integrally formed with the drawer bottom wall (101) by injection molding or pressing.

8. The multi-purpose coffee capsule storage drawer according to claim 1, wherein the protruding column (3) is in the shape of a rectangular column, or a circular column, or an elliptical column, or a polygonal column or an irregular column.

9. The multi-purpose coffee capsule storage drawer according to claim 1, further comprising an outer frame (6), wherein the drawer body (1) is installed in the outer frame (6) in a pull-out manner, and the plurality of protruding columns (3) in each row of positioning groups (10) are arranged along the pull-out direction.

10. The multi-purpose coffee capsule storage drawer according to claim 9, wherein roller grooves (11) are disposed on two sides of the drawer body (1), and rollers (7) slidably matched with the roller grooves (11) are disposed on corresponding two sides of the outer frame (6).

11. The multi-purpose coffee capsule storage drawer according to claim 1, wherein a handle (12) is installed on the front end side of the drawer body (1).
